(19) United States
(12) Patent Application Publication
(10) Pub. No.: US 2020/0055121 A1
(43) Pub. Date: Feb. 20, 2020

(54) METHOD OF CREATING A COMPONENT USING ADDITIVE MANUFACTURING

(71) Applicant: IMPERIAL COLLEGE INNOVATIONS LIMITED, London (GB)

(72) Inventors: Paul HOOPER, London (GB); Nan LI, London (GB); Jun JIANG, London (GB); Jianguo LIN, London (GB); Qian BAI, London (GB)

(73) Assignee: Imperial College Innovations Limited, London (GB)

(21) Appl. No.: 16/340,071

(22) PCT Filed: Oct. 5, 2017
(86) PCT No.: PCT/GB2017/053021

§ 371 Date: Apr. 5, 2019

(30) Foreign Application Priority Data
Oct. 5, 2016 (GB) 1616942.7

(51) Int. Cl. B22F 3/24; B22F 3/105; B22F 3/17; C22F 1/18; C22F 1/04; C22F 1/10; B33Y 10/00; B33Y 40/00; B21J 5/00

(52) U.S. Cl. CPC B22F 3/24; B22F 2301/15; B22F 3/17; C22F 1/183; C22F 1/04; C22F 1/10; B33Y 10/00; B33Y 40/00; B21J 5/002; B22F 2003/248; B22F 2003/247; B22F 2998/10; B22F 2301/205; B22F 2301/052; B22F 3/1055

(57) ABSTRACT

There is provided a method of manufacturing a component. The method comprises creating a preform from a material using additive manufacturing and heat treating the preform at a heating temperature to modify the microstructure of the material. The preform is geometrically unconstrained during the step of heat treating. The method then comprises compressive forming the preform into a predefined arrangement to create the component wherein the step of compressive forming is effective to close pores and diffusively bond the material. The material may then be geometrically constrained as it is cooled, for example within the die used for compressive forming.

### FIELD

The present disclosure relates to a method of creating a component using additive manufacturing.

### BACKGROUND

The manufacture of high-end safety critical components and difficult-to-form alloys is important for many applications, such as for use in vehicles or aero-engines. One example is the manufacture of thin, shell like components as a blade for an aero-engine.

Conventional processing routes for the manufacture of preforms for components involve a large number of forming and heat treatment steps using many different forming dies with relatively short life. These processing techniques produce a component with high-quality microstructure and excellent post-form properties but with a high cost and energy intensive manufacturing process. Also, using the conventional methods, there are greater difficulties to manufacture more complex-shaped preforms, for better in-service performance.

The aerospace industry is currently exploring the use of additive manufacturing to produce blades for aero engines.

The use of additive manufacturing (AM) techniques (also known as 3D printing) to directly manufacture final components overcomes the constraint on shape-complexity and the cost issues associated with the conventional approach. Additive manufacturing has the benefits that a component can be formed into the exact shape required from the final component, even if that shape is complex. Severe thermal fluctuation exists during the powder melting and cooling processes which result in the accumulation of residual stresses, porosity, and heterogeneous microstructure.

In an example of a current manufacturing process, the additive manufactured component is placed in a Hot Iso-static Press (HIP) to improve fatigue performance and finally CNC machined to give dimensional accuracy and improved surface finish. The cost of the HIP and CNC process is very high and the HIP does not produce a microstructure that performs as well as one produced by forging.

Accordingly, a method of manufacturing a component which addresses the problems associated with existing methods is required.

### SUMMARY

According to one aspect there is provided a method of manufacturing a component, the method comprising: creating a preform from a material using additive manufacturing; heat treating the preform at a heating temperature to modify the microstructure of the material, wherein the preform is geometrically unconstrained during the step of heat treating; and compressive forming the preform into a predefined arrangement to create the component, wherein the step of compressive forming is effective to close pores and diffusively bond the material.

A preform is created using additive manufacturing. The shape of the preform is optimised for the later stage of compressive forming. The compressive forming defines the final shape of the component, such that the preform created from manufacturing does not have to be precisely the shape of the component. The design of the preform shape, orientation for building and processing parameters are all optimised to create favourable conditions for the subsequent heat treatment and compressive forming operations.

The additive manufacturing technique may be any known additive manufacturing technique. For example, the additive manufacturing technique may be selective laser melting or electron beam melting using a metal alloy feedstock (e.g. powder, wire, etc). Severe thermal fluctuation exists during the additive manufacturing, which results in the accumulation of residual stresses, porosity, and heterogeneous microstructure.

The preform is then heat treated at a heating temperature, wherein the preform is geometrically unconstrained during the heat treatment. During the heat treatment, the microstructure of the preform can be homogenised, residual stresses can be eliminated, and desired microstructural evolutions (e.g. phase transformation, recrystallization, solution treating) can take place to achieve desired microstructure regarding phase composition, morphology etc.

The next step is compressive forming of the preform into a predefined configuration to form the component. The predefined configuration is determined according to the shape of the final component, and may be complex. During compressive forming, pores in the preform can be closed and diffusively bonded by the applied compressive stress. Compressive forming also improves microstructure through plastic flow of the material.

The method provides a manufactured component with reduced costs compared to known methods. Heat treating the component wherein the component is geometrically unconstrained is cheaper than hot iso-static press heating seen in the prior art. The present method avoids the problem of multiple stages of heat treating and forming which leads to a short life span of dies. The present method results in a geometrically accurate component with improved microstructure and mechanical properties compared to known methods.

Optionally, the method further comprises cooling the component after forming to allow microstructural change to complete, wherein the component is geometrically constrained during the step of cooling. The geometrical constraint ensures high dimensional accuracy of the component. The cooling is beneficial to minimise final distortion due to spring back, non-uniform thermal expansion and phase transformation. This process gives the component both complex high-precision shape and an optimal microstructure that possesses excellent mechanical properties, particularly regarding structural integrity. The combination of the heat treating and compressive forming steps, together with the constraints applied during cooling, can not only contribute to minimising or eliminating distortion but also can enlarge the available parameter windows for the compressive forming step. Consequently, significant increases in plastic flow can be achieved such that diffusion bonding and recrystallization can more effectively take place to provide improved microstructure.

Optionally, the heating temperature can be varied during heating. Optionally the heating temperature and/or the temperature during compressive forming is determined according to the preform material. Optionally, the component cools during the step of compressive forming.

Optionally, the preform material is: titanium alloy, such as two-phase titanium alloy or Ti-6Al-4V; titanium steel; boron steel; gamma TiAl intermetallics; Ni based superalloy or aluminium. In this case, the elastic stored energy during forging and cooling (causing spring back) can transfer into plastic energy due to the martensite phase transformation such that the minimum distortion can be achieved.

Optionally, the heating temperature during the heat treating step is between 300° C. below β-transus temperature and β-transus temperature. Optionally, the temperature of the preform at the start of compressive forming is below β-transus temperature. Optionally, the temperature of the preform at the end of compressive forming is above β to α phase transformation temperature. Optionally, the rate of change of temperature of the preform during compressive forming is such that the material stays in beta phase.

Optionally, the compressive forming is forging. The preform is formed into the shape of the final component using forging. Thus the shape of the preform made using additive manufacturing does not have to be exact to the shape of the final component. Forging closes the pores in the preform and improves microstructure through plastic flow of the material.

Optionally, the compressive forming is performed using a die. Optionally, the die has a temperature of less than 500° C. Optionally the die has a temperature of less than 350° C. Forming using a die can be done in a single process.

Optionally, the component is held in the die for a period of time after forming. The period depends on the specific material of the component. Optionally, the period is from 1 to 600 seconds. This allows diffusion bonding to be completed for better structural integrity. In-die holding does not require moving the component from the compressive forming equipment, and leading to a simpler process. The geometrical constraint of the die ensures high dimensional accuracy of the component. The cooling minimises final distortion due to spring back, non-uniform thermal expansion and phase transformation. This process gives the component both complex high-precision shape and an optimal microstructure that possesses excellent mechanical properties, particularly regarding structural integrity. As mentioned above, not only does this “in-die quenching” process contribute to reduced or eliminated distortion but it also can enlarge the available parameter windows for the compressive forming step. Consequently, significant increases in plastic flow can be achieved such that diffusion bonding and recrystallization can more effectively take place to provide improved microstructure.

Optionally, the method further comprises trimming the component. Slight imperfections in the exterior of the component can be addressed in this step to finalise the component. The component may be trimmed of minor parts to create the ideal net-shape for the use of the component.

Optionally, an orientation of additive manufacturing and/or the shape of the preform are optimised for subsequent heat treatment and compressive forming to produce compressive stress states and plastic flow in directions that align the microstructure. This provides better performance of the component under in-service loading conditions.

Optionally, the method further comprises filling internal features in the preform with a second material before compressive forming, and subsequently removing the second material after compressive forming. Optionally, the second material is removed via dissolving, melting or mechanical methods. Therefore the method can be used to manufacture hollow components or components with internal features.

### BRIEF DESCRIPTION OF THE DRAWINGS

Specific embodiments are described below by way of example only and with reference to the accompanying drawings in which:

FIG. 1 is a process diagram illustrating a method of manufacturing a component;

FIG. 2 illustrates example processing temperature during the method of manufacturing a component;

FIG. 3 is a graph of the degree of distortion in a shell type component as a function of holding time.

### SPECIFIC DESCRIPTION OF CERTAIN EXAMPLE EMBODIMENTS

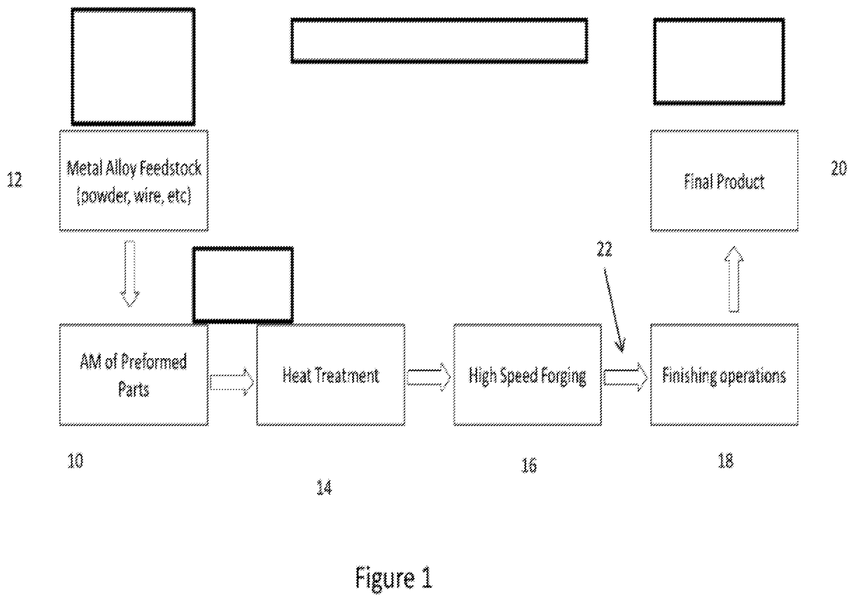

FIG. 1 illustrates a method of manufacturing a component according to the present invention.

At step 10, additive manufacturing is used to create a preform. Additive manufacturing uses metal alloy feedstock (powder or wire or the like) as shown at 12. The material may be titanium alloys or steels. Electron beam melting (EBM) or laser melting is then used to form the feedstock into a preform of a desired shape. The shape of the preform may be complex. Because the final net-shape of the component is obtained later in the process, the additive manufacturing does not need to accurately create the shape of the final component. Thus the shape of the preform is different to the final net-shape of the component. Further, because the microstructure of the preform is changed later in the process, the final microstructure properties do not need to be achieved in the additive manufacturing stage, which makes the additive manufacturing considerations less complex and reduces cost.

The preform design, build parameters and orientation of the additive manufacturing are optimised for subsequent forming operations, to produce compressive stress states and plastic flow of the material in directions that align the microstructure in the subsequent stages of the method. The additive manufacture parameters are not designed to create a preform with the microstructure or shape of the final component or to reduce pore properties.

Severe thermal fluctuation exists in additive manufacturing during the powder melting and cooling processes which result in the accumulation of residual stresses, porosity, and heterogeneous microstructure.

In step 14, the preform is heated. The preform is not geometrically constrained during heating. The preform is formed into the final shape of the component later in the process, such that during the heating phase the precise shape of the component does not need to be maintained through geometric constraint. The heating temperature and time of heating is chosen to homogenize the microstructure of the preform. Also during heating further desired microstructural evolutions take place. These include phase transformation, recrystallization and solution treating. Such evolutions benefit the properties of the final component. The heat treatment as used to achieve the desired microstructure regarding phase composition, morphology, and other microstructure properties.

The heat treated preform is quickly moved into a low-temperature die set, and high strain rate is applied to forge it into its final geometry such that all pores can be closed and diffusively bonded by applied compressive stress at step 16. Step 16 is high-speed forging of the preform into a component. The preform is compressively formed into the final net-shape of the component. The forging may be done using dies moulded to the final net shape.

Additive manufacturing can lead to pores in the preform. Compressive forming the preform closes up the pores to reduce the porosity of the component. The speed and the temperature of the forming close up the pores. The compressive stress applied during forging, and in-die holding if needed (discussed below) diffusively bonds the material of the preform. Further, plastic flow in the preform during forging leads to further improved microstructure.

Because the preform is compressively formed into the final net shape, the preform does not initially have to be precisely shaped to the final net-shape of the component, meaning that the additive manufacturing can be done using considerations about the compressive stresses during the compressive forming. The shape of the preform created from additive manufacturing (step 10) is not confined or restricted by the exact shape of the final component, because the shape of the final component is achieved at a later stage (step 14).

At step 18 the component is removed from the die and finishing operations are performed. These may be trimming excess minor defects from the edges of the component. The finishing operations do not substantially change the shape or the microstructure of the component.

The component is completed and ready for use at step 20. The component has the desired shape achieved through high-speed forging at step 16, and desired microstructure properties achieved through heat treating at step 14 and high speed forging at step 16 (and additionally through the optional step of in-die holding at step 22). The shape of the preform, additive processing orientations, and die design are optimised to produce compressive stress states and plastic flow of the material in directions that align the microstructure.

Optionally, the process includes a further step 22 of controlled cooling through in-die holding after high speed forming (step 16) and before the finishing operation (step 18). The component is cooled with a geometrical constraint. Where the high-speed forming is done using a die, the preform is held in the dies for a period of time for controlled cooling. The die geometrically constrains the component in the final net shape to provide high dimensional accuracy. The period allows controlled microstructural change to complete, and is chosen dependent on the material of the component. The period is determined based on the material of the component. In this embodiment, the period is from 1 to 600 seconds. When the material of the component is titanium alloys or steels, the elastic stored energy during forging and cooling (causing spring back) can transfer into plastic energy due to the martensite phase transformation such that the minimum distortion can be achieved.

The process is useful for forming thin, shell-type components.

Compressive forming of components with internal features (hollow parts for cooling channels, weight saving, etc) can be achieved by filling the features with a material prior to application of compressive stress and then subsequently removing the material (via dissolving, melting or mechanical methods).

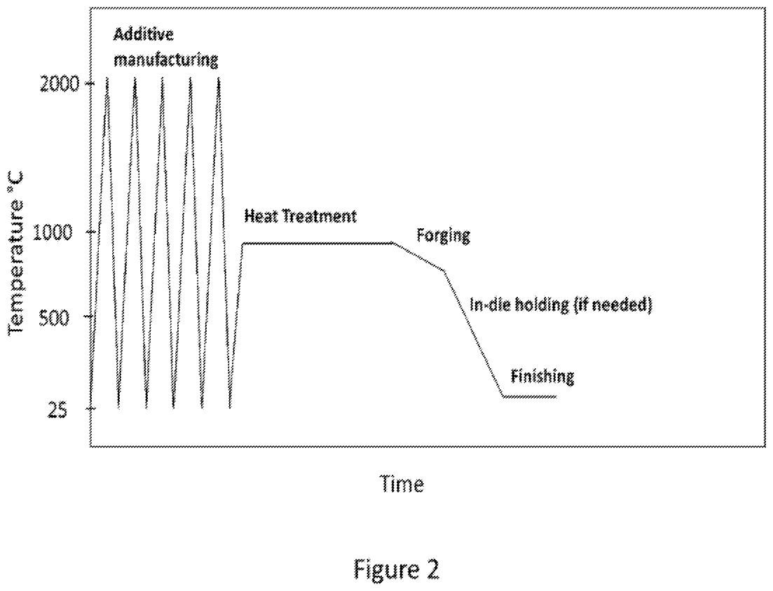

FIG. 2 illusrates an example processing temperature of the preform throughout the process of FIG. 1.

During additive manufacturing the temperature of the preform whilst being created fluctuates dramatically. This leads to a heterogeneous microstructure. The heating temperature of the preform is chosen to cause the desired microstructural changes.

During forging the preform cools (indicated by the gradient on the graph). The forging is performed quickly such that the pores are closed up and further microstructural changes complete.

The component is then cooled further whilst being held in the die. The in-die cooling reduces distortion and achieves high dimensional accuracy of the component. Finally, the component is removed from the die at room temperature and the finishing operations are performed to result in the final component.

In one example, the material of the preform is two-phase titanium alloy. In this case, the heating temperature during the heat treating step is between 300° C. below β-transus temperature and β-transus temperature. The temperature of the preform at the start of compressive forming is below β-transus temperature. The temperature of the preform at the end of compressive forming is above β to α phase transformation temperature. The rate of change of temperature of the preform during compressive forming is such that the material stays in beta phase.

The heating temperature may vary during the heat treating step.

Examples of temperatures for specific materials are given in the below table:

| | | | | Rate of change |
|---|---|---|---|---|
| | | | T at end of | of T during |
| Material | Heating T | T at start of forming | forming | forming |
| Ti—6Al—4V | 700-1000° C. | <1000° C., preferably | >780° C., | >18° C./s |
| | | 850-1000° C. | preferably 800-850° C. | |
| Boron steel (eg | 850-950° C. | <950° C., preferably | >400° C., | >27° C./s |
| 22MnB5) | | 727-950° C. | preferably >650° C. | |

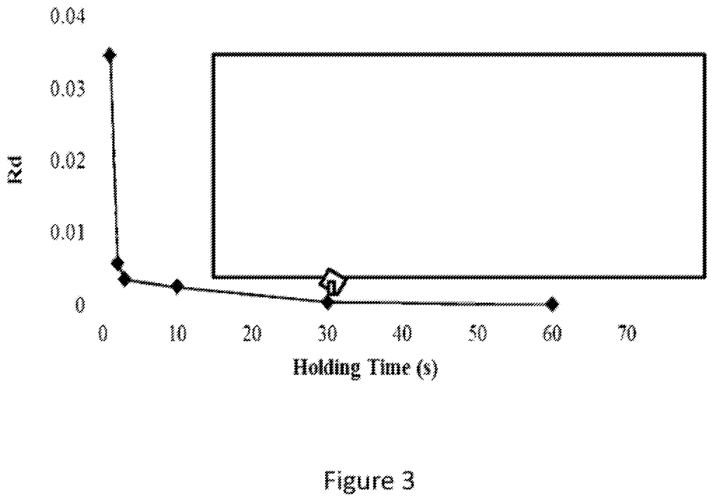

Laboratory investigations showing the effects of the in-die holding after compressive forming (e.g. forging) are illustrated in FIG. 3. In the figure, Rd represents the degree of distortion, equals to the ratio of the maximum vertical distance between the formed work-piece and the forming tool surface to the maximum vertical distance between the un-deformed workpiece and the forming tool surface. If Rd equals to 0, there is no distortion. It shows that the distortion could be significantly reduced by applying in-die holding in the method of FIG. 1 and be completely eliminated by being held for 30s.

Thus is provided a method of manufacturing a component, utilising additive manufacturing and compressive forming to overcome limitations on manufacturing efficiency and component performance. Three main adverse factors in additively manufactured structural materials, namely residual stress, porosity and heterogeneous microstructure can be eliminated by the proposed approach.

1. A method of manufacturing a component, the method comprising:
creating a preform from a material using additive manufacturing;
heat treating the preform at a heating temperature to modify the microstructure of the material wherein the preform is geometrically unconstrained during the step of heat treating; and
compressive forming the preform into a predefined arrangement to create the component wherein the step of compressive forming is effective to close pores and diffusively bond the material.

2. A method according to claim 1 further comprising cooling the component after forming to allow microstructural change to complete, wherein the component is geometrically constrained during the step of cooling.

3. A method according to any of the above claims wherein the component cools during the step of compressive forming.

4. A method according to any of the above claims wherein at least one of: the heating temperature, the temperature of the preform at the start of forming, the temperature of the preform at the end of forming, and the rate of change of temperature of the preform during forming is selected depending on the material of the preform.

5. A method according to any of the above claims wherein the preform material is: titanium alloy, such as two-phase titanium alloy or Ti-6Al-4V; titanium steel; boron steel; gamma TiAl intermetallics; Ni based superalloy or aluminium.

6. A method according to any of the above claims wherein the heating temperature during the heat treating step is between 300° C. below β-transus temperature and β-transus temperature.

7. A method according to any of the above claims wherein the temperature of the preform at the start of compressive forming is below β-transus temperature.

8. A method according to any of the above claims wherein the temperature of the preform at the end of compressive forming is above β to α phase transformation temperature.

9. A method according to any of the above claims wherein the rate of change of temperature of the preform during compressive forming is such that the material stays in beta phase.

10. A method according to any of the above claims wherein the compressive forming is forging.

11. A method according to any of the above claims, wherein the compressive forming is performed using a die.

12. A method according to claim 11 wherein the die has a temperature of less than 500° C., and preferably less than 300° C.

13. A method according to claim 11 or claim 12, wherein the component is held in the die for a period of time after forming.

14. A method according to claim 13, wherein the period is from 1 to 600 seconds.

15. A method according to any of the above claims further comprising trimming the component.

16. A method according to any of the above claims, wherein an orientation of additive manufacturing and/or the shape of the preform are optimised for subsequent heat treatment and compressive forming to produce compressive stress states and plastic flow in directions that align the microstructure.

17. A method according to any of the above claims further comprising filling the preform with a second material prior to compressive forming, and subsequently removing the second material after compressive forming.

18. A method according to claim 17, wherein the second material is removed via dissolving, melting or mechanical methods.
